(19) United States
(12) Patent Application Publication
(10) Pub. No.: US 2026/0279255 A1
(43) Pub. Date: Sep. 17, 2026

(54) DISPLAY DEVICE AND ELECTRONIC DEVICE INCLUDING THE SAME

(71) Applicant: Samsung Display Co., LTD., Yongin-si (KR)

(72) Inventors: Heeeun LEE, Yongin-si (KR); HYUNWOONG KIM, Yongin-si (KR); BYUNGSOO YOU, Yongin-si (KR)

(21) Appl. No.: 19/385,551

(22) Filed: Nov. 11, 2025

(30) Foreign Application Priority Data
Mar. 12, 2025 (KR) 10-2025-0032327

(51) Int. Cl. G09G 3/32

(52) U.S. Cl. CPC G09G 3/32; G09G 2300/0819; G09G 2310/0267; G09G 2310/0275; G09G 2320/0233; G09G 2330/028

(57) ABSTRACT

A display device includes a pixel circuit, a gate driver, a data driver which applies a data voltage to the display panel and a voltage generator which applies a driving voltage to the display panel. The pixel circuit includes a driving transistor which generates a driving current based on the data voltage and a light emitting element which emits light based on the driving current. The driving voltage includes an initialization voltage applied to a control electrode of the driving transistor. The initialization voltage is changed based on a setting luminance of the display panel. When the initialization voltage is changed, the data voltage has a voltage level which is a sum of a setting data voltage level and an offset voltage level.

This application claims priority to Korean Patent Application No. 10-2025-0032327, filed on Mar. 12, 2025, and all the benefits accruing therefrom under 35 U.S.C. § 119, the content of which in its entirety is herein incorporated by reference.

### BACKGROUND

### 1. Field

Embodiments of the invention relate to a display device and an electronic device including the display device. More particularly, embodiments of the invention relate to a display device in which a display quality is improved and an electronic device including the display device.

### 2. Description of the Related Art

Generally, a display device includes a display panel and a display panel driver. The display panel may include a plurality of gate lines, a plurality of data lines, a plurality of emission lines and a plurality of pixels. The display panel driver may include a gate driver for providing a gate signal to the gate lines, a data driver for providing a data voltage to the data lines, an emission driver for providing an emission signal to the emission lines and a driving controller for controlling the gate driver, the data driver and the emission driver.

Generally, a driving voltage of a display device may be changed for reducing a power consumption of the display device.

### SUMMARY

Embodiments of the invention provide a display device in which a display quality is improved.

Embodiments of the invention provide an electronic device in which a display quality is improved.

According to embodiments, a display device includes a display panel including a pixel circuit, a gate driver which outputs a gate signal to the pixel circuit, a data driver which applies a data voltage to the display panel, a voltage generator which applies a driving voltage to the display panel and a driving controller which controls the gate driver, the data driver and the voltage generator. In such embodiments, the pixel circuit includes a driving transistor which generates a driving current based on the data voltage and a light emitting element which emits light based on the driving current. In such embodiments, the driving voltage includes an initialization voltage applied to a control electrode of the driving transistor, and the initialization voltage is changed based on a setting luminance of the display panel. In such embodiments, when the initialization voltage is changed, the data voltage has a voltage level which is a sum of a setting data voltage level and an offset voltage level.

In an embodiment, when the setting luminance is a first setting luminance, the initialization voltage may have a first initialization voltage level, and the data voltage may have the setting data voltage level corresponding to the first setting luminance. In such an embodiment, the setting luminance may be a second setting luminance higher than the first setting luminance, the initialization voltage may have a second initialization voltage level different from the first initialization voltage level, and the data voltage may have a voltage which is a sum of the setting data voltage level corresponding to the second setting luminance and a first offset voltage level.

In an embodiment, the second initialization voltage level may be lower than the first initialization voltage level.

In an embodiment, the setting luminance may be a third setting luminance higher than the second setting luminance, the initialization voltage may have a third initialization voltage level different from the first initialization voltage level and the second initialization voltage level, and the data voltage may have a voltage which is a sum of the setting data voltage level corresponding to the third setting luminance and a second offset voltage level. In such an embodiment, the second offset voltage level may be different from the first offset voltage level.

In an embodiment, a voltage level difference between the second offset voltage level and the first offset voltage level may be different from the first offset voltage level.

In an embodiment, a change rate of the offset voltage level may be changed based on the setting luminance.

In an embodiment, the setting data voltage level may be determined based on a grayscale voltage lookup table corresponding to the setting luminance.

In an embodiment, when the setting luminance may be equal to or higher than a reference setting luminance, the setting data voltage level may be determined based on one grayscale voltage lookup table of a plurality of grayscale voltage lookup tables. In such an embodiment, the one grayscale voltage lookup table may be generated through a linear interpolation to a reference grayscale voltage lookup table stored at the reference setting luminance and a maximum grayscale voltage lookup table stored at a luminance setting luminance.

In an embodiment, the offset voltage level may be determined based on a change of the initialization voltage.

In an embodiment, the light emitting element may include a first electrode which receives the driving current and a second electrode which receives a low power voltage. In such an embodiment, when the low power voltage is changed, the initialization voltage may be changed.

In an embodiment, the data voltage may include a red data voltage, a green data voltage and a blue data voltage. In such an embodiment, when the initialization voltage is changed, the red data voltage may have a voltage level which is a sum of a red setting data voltage level and a red offset voltage level. In such an embodiment, when the initialization voltage is changed, the green data voltage may have a voltage level which is a sum of a green setting data voltage level and a green offset voltage level. In such an embodiment, when the initialization voltage is changed, the blue data voltage may have a voltage level which is a sum of a blue setting data voltage level and a blue offset voltage level. In such an embodiment, the red offset voltage level, the green offset voltage level and the blue offset voltage level may be different from each other.

In an embodiment, the green offset voltage level may be higher than the red offset voltage level. In such an embodiment, the red offset voltage level may be higher than the blue offset voltage level.

According to embodiments, a display device includes a display panel including a pixel circuit and a display panel driver which drives the display panel. In such embodiments, the display panel driver applies a data voltage and an initialization voltage to the display panel, and the initialization voltage is changed based on a setting luminance of the display panel. In such embodiments, when the setting luminance is lower than a reference setting luminance, the data voltage is decreased from a first data voltage level to a second data voltage level based on an increase of the setting luminance. In such embodiments, when the setting luminance is equal to or higher than the reference setting luminance, the data voltage is decreased from a third data voltage level to a fourth data voltage level based on an increase of the setting luminance. In such embodiments, the third data voltage level is higher than the second data voltage level.

In an embodiment, when the setting luminance is lower than the reference setting luminance, the initialization voltage may have a first initialization voltage level. In such an embodiment, when the setting luminance is equal to or higher than the reference setting luminance, the initialization voltage may be decreased from the first initialization voltage.

In an embodiment, when the setting luminance is lower than the reference setting luminance, the data voltage may have a setting data voltage level corresponding to the setting luminance. In such an embodiment, when the setting luminance is equal to or higher than the reference setting luminance, the data voltage may have a voltage level which is a sum of the setting data voltage level corresponding to the setting luminance and an offset voltage level.

In an embodiment, the setting data voltage level may be determined based on a grayscale voltage lookup table corresponding to the setting luminance. In such an embodiment, when the setting luminance is equal to or higher than a reference setting luminance, the setting data voltage level may be determined based on one grayscale voltage lookup table of a plurality of grayscale voltage lookup tables. In such an embodiment, the one grayscale voltage lookup table may be generated through a linear interpolation to a reference grayscale voltage lookup table stored at the reference setting luminance and a maximum grayscale voltage lookup table stored at a luminance setting luminance.

According to embodiments, an electronic device may include a display panel including a pixel circuit, a gate driver which outputs a gate signal to the pixel circuit, a data driver which applies a data voltage to the display panel, a voltage generator which applies a driving voltage to the display panel, a driving controller which controls the gate driver, the data driver and the voltage generator based on an input control signal and a processor which outputs the input control signal. In such embodiments, the pixel circuit includes a driving transistor which generates a driving current based on the data voltage and a light emitting element which emits light based on the driving current. In such embodiments, the driving voltage includes an initialization voltage applied to a control electrode of the driving transistor, and the initialization voltage is changed based on a setting luminance of the display panel. In such embodiments, when the initialization voltage is changed, the data voltage has a voltage level which is a sum of a setting data voltage level and an offset voltage level.

In an embodiment, when the setting luminance is a first setting luminance, the initialization voltage may have a first initialization voltage level, and the data voltage may have the setting data voltage level corresponding to the first setting luminance. In such an embodiment, the setting luminance may be a second setting luminance higher than the first setting luminance, the initialization voltage may have a second initialization voltage level different from the first initialization voltage level, and the data voltage may have a voltage which is a sum of the setting data voltage level corresponding to the second setting luminance and a first offset voltage level.

In an embodiment, the setting luminance may be a third setting luminance higher than the second setting luminance, the initialization voltage may have a third initialization voltage level different from the first initialization voltage level and the second initialization voltage level, and the data voltage may have a voltage which is a sum of the setting data voltage level corresponding to the third setting luminance and a second offset voltage level. In such an embodiment, the second offset voltage level may be different from the first offset voltage level.

In an embodiment, the offset voltage level may be determined based on a change of the initialization voltage.

In embodiments of the invention, as described above, the initialization voltage may be changed based on the setting luminance. When the initialization voltage is changed based on the setting luminance, the offset voltage level may be considered in the data voltage. The offset voltage level may be a voltage level based on a change of the initialization voltage. The data voltage may have a voltage level based on the setting data voltage level and the offset voltage level. In such embodiments, since the offset voltage level may be considered in the data voltage, a change of the voltage level of the initialization voltage may be considered in the data voltage. In such embodiments, since a change of the voltage level of the initialization voltage may be considered in the data voltage, a reliability of a driving current outputted by a driving transistor included in the pixel circuit may be improved. In such embodiments, since the reliability of the driving current outputted by the driving transistor may be improved, a luminance uniformity of the display panel may be improved. Accordingly, a display quality of the display panel may be improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments of the invention.

FIG. 2 is a circuit diagram illustrating an example of a pixel circuit included in a display device of FIG. 1.

FIG. 3 is a graph illustrating a relationship between an initialization voltage applied to a pixel circuit of FIG. 2 and a setting luminance.

FIG. 4 is a table illustrating an example of a grayscale voltage lookup table of a setting data voltage level of a data voltage applied to a pixel circuit of FIG. 2.

FIG. 5 is a graph illustrating an example of a method for generating a grayscale voltage lookup table of FIG. 4.

FIG. 6 is a table illustrating setting data voltage levels of FIG. 4 corresponding to a setting luminance.

FIG. 7 is a table illustrating an example of a data voltage applied to a pixel circuit of FIG. 2.

FIG. 8 is a table illustrating an example of an offset voltage level considered for data voltage of FIG. 6.

FIG. 9 is a graph illustrating an example of an offset voltage level considered for a data voltage of FIG. 6.

FIG. 10 is a graph illustrating an example of a data voltage in which a data driver included in a display device of FIG. 1 outputs.

FIG. 11 is a graph illustrating an example of a driving current of a driving transistor included in a pixel circuit of FIG. 2.

FIG. 12 is a graph illustrating a luminance of a display panel included in a display device of FIG. 1 and a luminance of a comparative example.

FIG. 13 is a table illustrating an example of a data voltage applied to a pixel circuit of FIG. 2.

FIG. 14 is a table illustrating an example of a data voltage applied to a pixel circuit of FIG. 2.

FIG. 15 is a table illustrating an example of a data voltage applied to a pixel circuit of FIG. 2.

FIG. 16 is a circuit diagram illustrating an example of a pixel circuit included in the display device of FIG. 1.

FIG. 17 is a block diagram illustrating an electronic device according to embodiments of the invention.

FIG. 18 to FIG. 20 are schematic diagrams illustrating an electronic device according to embodiments.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, embodiments of the invention will be described in detail with reference to the accompanying drawings.

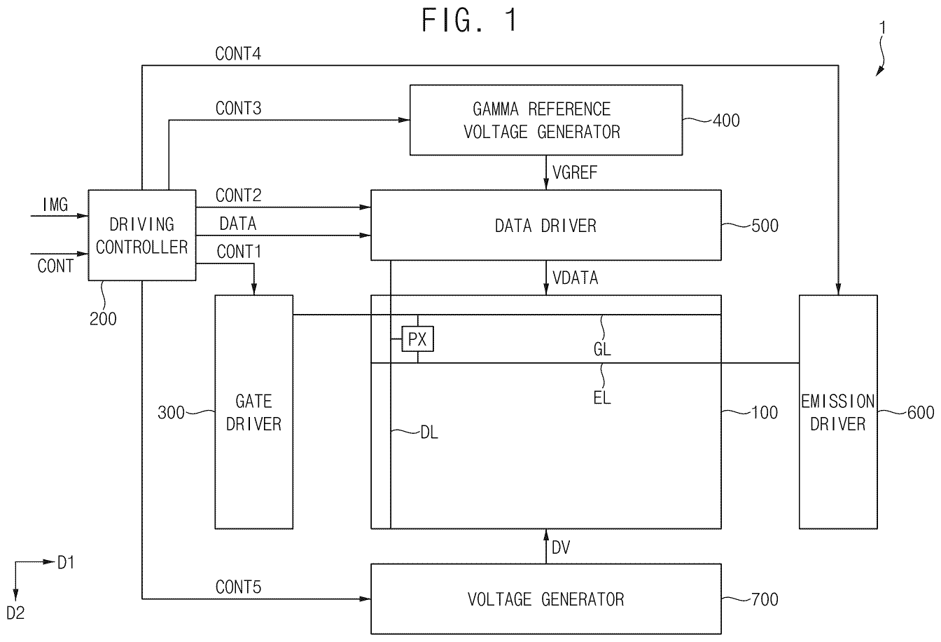

FIG. 1 is a block diagram illustrating a display device 1 according to embodiments of the invention.

Referring to FIG. 1, an embodiment of the display device 1 may include a display panel 100 and a display panel driver. The display panel driver may include a driving controller 200, a gate driver 300, a gamma reference voltage generator 400, a data driver 500, an emission driver 600 and a voltage generator 700.

The display panel 100 may include a display region on which an image is displayed and a peripheral region adjacent to the display region.

The display panel 100 may include a plurality of gate lines GL, plurality of emission lines EL, a plurality of data lines DL and a plurality of pixel circuit PX electrically connected to the gate lines GL, the emission lines EL and the data lines DL. The gate lines GL may extend in a first direction D1, the emission lines EL may extend in the first direction D1 and the data lines DL may extend in a second direction D2 crossing the first direction D1.

The driving controller 200 may receive input image data IMG and an input control signal CONT from an external apparatus. In an embodiment, for example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4, a fifth control signal CONT5 and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The driving controller 200 may generate the fourth control signal CONT4 for controlling an operation of the emission driver 600 based on the input control signal CONT, and output the fourth control signal CONT4 to the emission driver 600.

The driving controller 200 may generate the fifth control signal CONT5 for controlling an operation of the voltage generator 700 based on the input control signal CONT, and output the fifth control signal CONT5 to the voltage generator 700.

The gate driver 300 may generate gate signals driving the gate lines GL in response to the first control signal CONT1 received from the driving controller 200. The gate driver 300 may output the gate signals to the gate lines GL.

In an embodiment, the gate driver 300 may be disposed in the peripheral region. In an embodiment, the gate driver 300 may be integrated in the peripheral region.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to a level of the data signal DATA.

In an embodiment, the gamma reference voltage generator 400 may be disposed in the driving controller 200, or in the data driver 500.

The data driver 500 may receive the second control signal CONT2 and the data signal DATA from the driving controller 200, and receive the gamma reference voltages VGREF from the gamma reference voltage generator 400. The data driver 500 may convert the data signal DATA into data voltages VDATA having an analog type using the gamma reference voltages VGREF. The data driver 500 may output the data voltages VDATA to the data lines DL.

In an embodiment, the data driver 500 may be disposed in the peripheral region. In an embodiment, the data driver 500 may be integrated in the peripheral region.

The emission driver 600 may generate emission signal in response to the fourth control signal CONT4 received from the driving controller 200. The emission driver 600 may output the emission signal to the emission lines EL.

In an embodiment, the emission driver 600 may be disposed in the peripheral region. In an embodiment, the emission driver 600 may be integrated in the peripheral region.

Although an embodiment where the gate driver 300 is disposed on a first side of the display panel 100, and the emission driver 600 is disposed on a second side of the display panel 100 is shown in FIG. 1 for convenience of illustration and description, the invention is not limited thereto. In another embodiment, the gate driver 300 and the emission driver 600 may be disposed on the first side of the display panel 100. In an embodiment, for example, the gate driver 300 and the emission driver 600 may be disposed on the peripheral region of the display panel 100 on a same side of the display region of the display panel 100. In an embodiment, for example, the gate driver 300 and the emission driver 600 may be formed integrally with each other as a single chip.

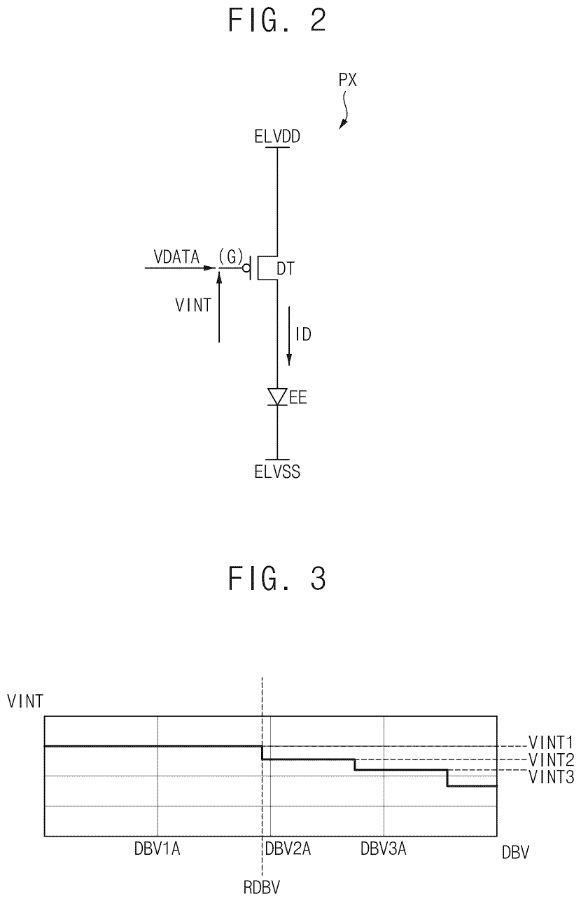

The voltage generator 700 may generate a driving voltage DV in response to the fifth control signal CONT5 received from the driving controller 200. The voltage generator 700 may output the driving voltage DV to the display panel 100. The driving voltage DV may include a high power voltage ELVDD of FIG. 2, a low power voltage ELVSS of FIG. 2 and an initialization voltage VINT of FIG. 2. A voltage level of the high power voltage ELVDD of FIG. 2 may be higher than a voltage level of the low power voltage ELVSS.

FIG. 2 is a circuit diagram illustrating an example of a pixel circuit PX included in a display device 1 of FIG. 1.

Referring to FIG. 1 and FIG. 2, an embodiment of the pixel circuit PX may include a driving transistor DT and a light emitting element EE.

The driving transistor DT may include a control electrode G, a first electrode that receives the high power voltage ELVDD and a second electrode connected to a light emitting element EE. The control electrode G of the driving transistor DT may receive the data voltage VDATA. The control electrode G of the driving transistor DT may receive the initialization voltage VINT. The control electrode G of the driving transistor DT may be initialized as the initialization voltage VINT. The driving transistor DT may generate a driving current ID based on the data voltage VDATA. The driving transistor DT may output the driving current ID to the light emitting element EE. In an embodiment, the driving transistor DT may be a P-type transistor. However, the invention is not limited to a type of the driving transistor DT.

The light emitting element EE may include a first electrode that receives the driving current ID and a second electrode that receives the low power voltage ELVSS. The first electrode of the light emitting element EE may be connected to the second electrode of the driving transistor DT. The light emitting element EE may emit light based on the driving current ID. The light emitting element EE may emit light with a luminance corresponding to the driving current ID.

FIG. 3 is a graph illustrating a relationship between an initialization voltage VINT applied to a pixel circuit PX of FIG. 2 and a setting luminance DBV.

Referring to FIG. 1 to FIG. 3, in an embodiment, the display panel 100 may emit light based on the setting luminance DBV. In an embodiment, for example, the setting luminance DBV may be a brightness set by a user. In an embodiment, for example, the setting luminance DBV may mean a maximum luminance which the display panel 100 displays. In an embodiment, for example, the setting luminance DBV may mean a maximum luminance which the display panel 100 displays a grayscale corresponding to white. In an embodiment, for example, the grayscale corresponding to white may be 255 grayscale level. However, the invention is not limited to a value of the grayscale corresponding to white. In an embodiment, for example, the setting luminance DBV may be about 3000 nit. In an embodiment, for example, the setting luminance DBV may be about 600 nit. However, the invention is not limited to a value of the setting luminance DBV.

In the present embodiment, the initialization voltage VINT may be changed based on the setting luminance DBV. In an embodiment, for example, when the setting luminance DBV is increased, a voltage level of the initialization voltage VINT may be decreased. In an embodiment, for example, when the setting luminance DBV is higher than a reference setting luminance RDBV, a voltage level of the initialization voltage VINT may be decreased. In an embodiment, for example, when the setting luminance DBV is lower than the reference setting luminance RDBV, the initialization voltage VINT may have a first initialization voltage level. In an embodiment, for example, when the setting luminance DBV is lower than the reference setting luminance RDBV, the initialization voltage VINT may be maintained as the first initialization voltage level. In an embodiment, for example, when the setting luminance DBV is higher than the reference setting luminance RDBV, the initialization voltage VINT may have a second initialization voltage level lower than the first initialization voltage level. The section where the setting luminance DBV is lower than the reference setting luminance RDBV may be referred to as a normal luminance section. The section where the setting luminance DBV is equal to or higher than the reference setting luminance RDBV may be referred to as a high luminance section.

In the first setting luminance DBVIA, the initialization voltage VINT may have a first initialization voltage level VINT1. In the second setting luminance DBV2A, the initialization voltage VINT may have a second initialization voltage level VINT2. The second setting luminance DBV2A may be higher than the first setting luminance DBVIA. The second initialization voltage level VINT2 may be lower than the first initialization voltage level VINT1. In the third setting luminance DBV3A, the initialization voltage VINT may have a third initialization voltage level VINT3. The third setting luminance DBV3A may be higher than the second setting luminance DBV2A. The third initialization voltage level VINT3 may be lower than the second initialization voltage level VINT2.

In an embodiment, the low power voltage ELVSS may be changed based on the setting luminance DBV. In an embodiment, for example, when the setting luminance DBV is increased, a voltage level of the low power voltage ELVSS may be decreased. In an embodiment, for example, when the setting luminance DBV is decreased, the voltage level of the low power voltage ELVSS may be increased. In an embodiment, for example, in the high luminance section, the voltage level of the low power voltage ELVSS can be decreased.

When the setting luminance DBV is increased, the voltage range of the data voltage VDATA applied to the control electrode G of the driving transistor DT may be increased. In an embodiment, for example, when the setting luminance DBV is increased, the minimum value of the data voltage VDATA applied to the control electrode G of the driving transistor DT may be decreased. The initialization voltage VINT may be changed based on the setting luminance DBV. Accordingly, the control electrode G of the driving transistor DT may be initialized more stably. Accordingly, the display quality of the display panel 100 may be improved.

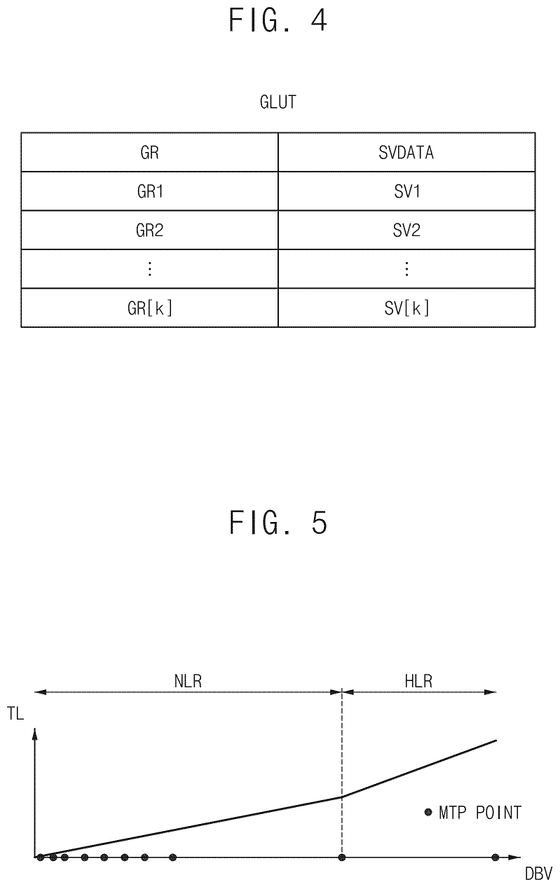

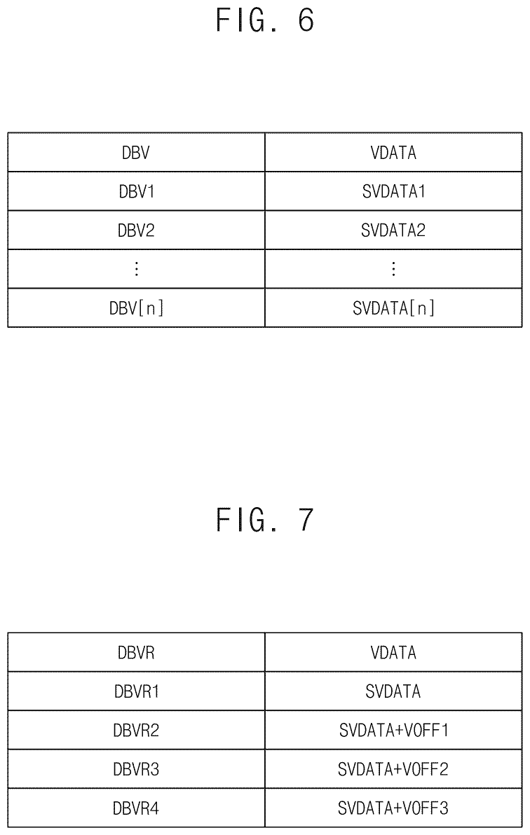

FIG. 4 is a table illustrating an example of a grayscale voltage lookup table GLUT of a setting data voltage level SVDATA of a data voltage VDATA applied to a pixel circuit PX of FIG. 2. FIG. 5 is a graph illustrating an example of a method for generating a grayscale voltage lookup table GLUT of FIG. 4. FIG. 6 is a table illustrating setting data voltage levels SVDATA of FIG. 4 corresponding to a setting luminance DBV.

Referring to FIG. 1 to FIG. 6, in an embodiment, the data voltage VDATA may be generated based on a setting data voltage level SVDATA. The data driver 500 may output the data voltage VDATA based on the setting data voltage level SVDATA. The setting data voltage level SVDATA may mean a voltage level corresponding to a specific grayscale level. In an embodiment, for example, a grayscale voltage lookup table GLUT corresponding to each setting luminance DBV may be stored. In an embodiment, the driving controller 200 may store a plurality of grayscale voltage lookup tables GLUT. In an embodiment, for example, a first setting data voltage level group corresponding to a first setting luminance may be stored. The first set voltage level group may include a first voltage level SV1 corresponding to a first grayscale GR1, a second voltage level SV2 corresponding to a second grayscale GR2, and a K-th voltage level SV[k] corresponding to a K-th grayscale GR[k]. Herein, K may be a positive integer. The first grayscale GR1 may correspond to the minimum luminance displayed by the pixel circuit PX. In an embodiment, for example, when the first voltage level SV1 is applied to the pixel circuit PX, the pixel circuit PX may display black. In an embodiment, for example, when the first voltage level SV1 is applied to the pixel circuit PX, the driving transistor DT may be turned off. The K-th grayscale GR[k] may correspond to the maximum luminance displayed by the pixel circuit PX.

A gamma reference voltage offset lookup table GRLUT may include the setting data voltage levels SVDATA corresponding to grayscales that a pixel circuit PX may output. In an embodiment, the setting data voltage level SVDATA considering panel characteristics may be determined using a measuring device in a manufacturing process of a display device 1. In an embodiment, a multi-time programming (MTP) operation may be performed in a manufacturing process of the display device 1 to repeatedly correct the display device 1 in terms of luminance and/or color coordinates. A plurality of grayscale voltage lookup tables GRLUT corresponding to a target luminance TL may be generated through the MTP operation. A plurality of grayscale voltage lookup tables GRLUT may be generated through the MTP operation. However, the invention is not limited to a method for generating a plurality of grayscale voltage offset lookup tables GRLUT. In a manufacturing process of a display device 1, the grayscale voltage lookup tables GLUT corresponding to setting luminance points may be stored. In an embodiment, for example, a first grayscale voltage offset lookup table corresponding to a first setting luminance may be stored. In an embodiment, for example, a third grayscale voltage offset lookup table corresponding to a third setting luminance may be stored. In the normal luminance section, a plurality of grayscale voltage lookup tables GLUT corresponding to a plurality of setting luminances DBV may be stored. In the normal luminance section NLR, the number of the plurality of setting luminances may be set by a setter. In the high luminance section HLR, a grayscale voltage lookup table GLUT corresponding to a reference setting luminance RDBV may be stored. In the high luminance section HLR, the grayscale voltage lookup table GLUT corresponding to the maximum setting luminance may be stored.

A second grayscale voltage offset lookup table corresponding to a second setting luminance may be determined by performing linear interpolation on the first grayscale voltage offset lookup table and the third grayscale voltage offset lookup table. The second setting luminance may be higher than the first setting luminance. The second setting luminance may be lower than the third setting luminance. In an embodiment, for example, a first voltage level SV1 corresponding to the second setting luminance may be determined by performing linear interpolation on a first voltage level SV1 corresponding to the first setting luminance and a first voltage level SV1 corresponding to the third setting luminance. In an embodiment, for example, a second voltage level SV2 corresponding to the second setting luminance may be determined by performing linear interpolation on a second voltage level SV2 corresponding to the first setting luminance and a second voltage level SV2 corresponding to the third setting luminance. In an embodiment, for example, a K-th voltage level SV[k] corresponding to the second setting luminance may be determined by performing linear interpolation on the K-th voltage level SV[k] corresponding to the first setting luminance and the K-th voltage level SV[k] corresponding to the third setting luminance.

The M-th grayscale voltage offset lookup table corresponding to the M-th setting luminance may be determined by performing linear interpolation on the grayscale voltage lookup table GLUT corresponding to the reference setting luminance RDBV and the grayscale voltage lookup table GLUT corresponding to the maximum setting luminance. The M-th setting luminance may be higher than the reference setting luminance RDBV. The M-th setting luminance may be lower than the maximum setting luminance. In an embodiment, for example, a first voltage level SV1 corresponding to the M-th setting luminance may be determined by performing linear interpolation on a first voltage level SV1 corresponding to the reference setting luminance RDBV and a first voltage level SV1 corresponding to the maximum setting luminance. In an embodiment, for example, a second voltage level SV2 corresponding to the M-th setting luminance may be determined by performing linear interpolation on a second voltage level SV2 corresponding to the reference setting luminance RDBV and a second voltage level SV2 corresponding to the maximum setting luminance. In an embodiment, for example, a K-th voltage level SV[k] corresponding to the M-th setting luminance may be determined by performing linear interpolation on a K-th voltage level SV[k] corresponding to the reference setting luminance RDBV and a K-th voltage level SV[k] corresponding to the maximum setting luminance.

The first setting data voltages SVDATA1 may correspond to the first setting luminance DBV1. When the display panel 100 is driven at the first setting luminance DBV1, the data driver 500 may output the data voltage VDATA based on the first setting data voltages SVDATA1. The second setting data voltages SVDATA2 may correspond to the second setting luminance DBV2. When the display panel 100 is driven at the second setting luminance DBV2, the data driver 500 may output the data voltage VDATA based on the second setting data voltages SVDATA2. The first setting data voltages SVDATA1 may correspond to the first setting luminance DBV1. When the display panel 100 is driven at the N-th setting luminance DBV[n], the data driver 500 may output a data voltage VDATA based on the N-th setting data voltages SVDATA[n]. Herein, N may be a positive integer.

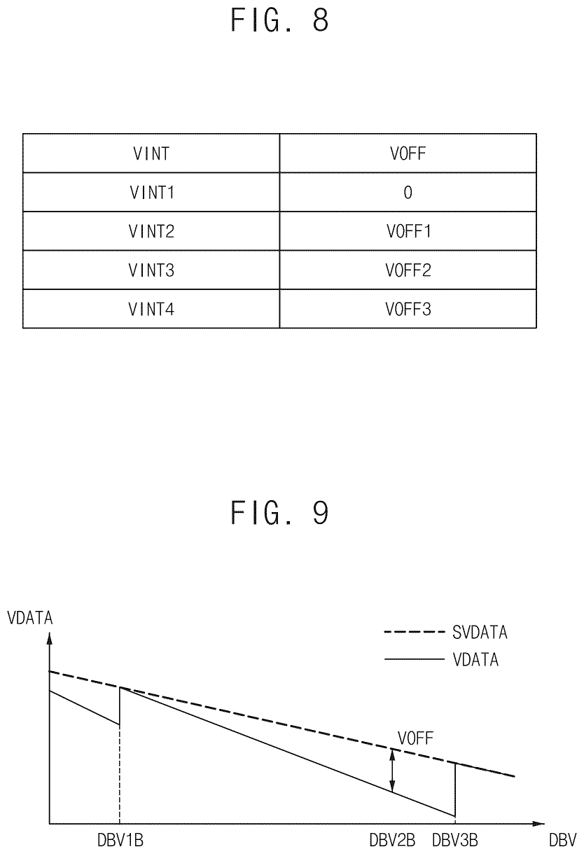

FIG. 7 is a table illustrating an example of a data voltage VDATA applied to a pixel circuit PX of FIG. 2. FIG. 8 is a table illustrating an example of an offset voltage level VOFF considered for data voltage VDATA of FIG. 6.

Referring to FIG. 1 to FIG. 8, in an embodiment, the data driver 500 may apply the data voltage VDATA to the pixel circuit PX based on the setting luminance range DBVR. In a first setting luminance range DBVR1, the data driver 500 may apply the setting data voltage level SVDATA to the pixel circuit PX. The first setting luminance range DBVR1 may include setting luminance DBV lower than the reference setting luminance RDBV. The first setting luminance range DBVR1 may include setting luminance DBV corresponding to the first initialization voltage level VINT1. In a second setting luminance range DBVR2, the data driver 500 may output a voltage level which is the sum of the setting data voltage level SVDATA and a first offset voltage level VOFF1 as the data voltage VDATA to the pixel circuit PX. The second setting luminance range DBVR2 may include setting luminances DBV that are equal to or higher than the reference setting luminance RDBV. The second setting luminance range DBVR2 may include setting luminances DBV that correspond to the second initialization voltage level VINT2. In a third setting luminance range DBVR3, the data driver 500 may output a voltage level which is a sum of the setting data voltage level SVDATA and the second offset voltage level VOFF2 as the data voltage VDATA to the pixel circuit PX. In an embodiment, the second offset voltage level VOFF2 may be equal to the first offset voltage level VOFF1. In an embodiment, a voltage level difference between the second offset voltage level VOFF2 and the first offset voltage level VOFF1 may be different from the first offset voltage level VOFF1, that is, the second offset voltage level VOFF2 is different from twice the first offset voltage level VOFF1. In an embodiment, the second offset voltage level VOFF2 may be higher than the first offset voltage level VOFF1. The third setting luminance range DBVR3 may include setting luminances DBV that are equal to or higher than the reference setting luminance RDBV. The third setting luminance range DBVR3 may include setting luminance DBV corresponding to the third initialization voltage level VINT3. In a fourth setting luminance range DBVR4, the data driver 500 may output a voltage level which is a sum of the setting data voltage level SVDATA and the third offset voltage level VOFF3 as the data voltage VDATA to the pixel circuit PX. The fourth setting luminance range DBVR4 may include setting luminances DBV which are equal to or higher than the reference setting luminance RDBV. The fourth setting luminance range DBVR4 may include setting luminances DBV corresponding to the fourth initialization voltage level VINT4. In an embodiment, the third offset voltage level VOFF3 may be equal to the second offset voltage level VOFF2. In another embodiment, the third offset voltage level VOFF3 may be higher than the second offset voltage level VOFF2.

In such an embodiment, the offset voltage level VOFF may be set based on a change of the initialization voltage VINT. In an embodiment, for example, the offset voltage level VOFF may be set based on a change of the voltage level of the initialization voltage VINT. In an embodiment, for example, when the initialization voltage VINT is changed from the first initialization voltage level VINT1 to the second initialization voltage level VINT2, the offset voltage level VOFF may be set based on a voltage level difference between the first initialization voltage level VINT1 and the second initialization voltage level VINT2. In an embodiment, when the initialization voltage VINT is changed from the first initialization voltage level VINT1 to the second initialization voltage level VINT2, a value obtained by multiplying the voltage level difference between the first initialization voltage level VINT1 and the second initialization voltage level VINT2 by a constant may be set as the offset voltage level VOFF.

In an embodiment, for example, when the initialization voltage VINT is changed from the second initialization voltage level VINT2 to the third initialization voltage level VINT3, the offset voltage level VOFF may be set based on the voltage level difference from the first initialization voltage level VINT1 to the third initialization voltage level VINT3. In an embodiment, when the initialization voltage VINT is changed from the second initialization voltage level VINT2 to the third initialization voltage level VINT3, a value obtained by multiplying the voltage level difference from the first initialization voltage level VINT1 to the third initialization voltage level VINT3 by a constant may be set as the offset voltage level VOFF.

In an embodiment, for example, when the initialization voltage VINT is changed from the third initialization voltage level VINT3 to the fourth initialization voltage level VINT4, the offset voltage level VOFF may be set based on the voltage level difference from the first initialization voltage level VINT1 to the fourth initialization voltage level VINT4. In an embodiment, when the initialization voltage VINT is changed from the third initialization voltage level VINT3 to the fourth initialization voltage level VINT4, a value obtained by multiplying the voltage level difference from the first initialization voltage level VINT1 to the fourth initialization voltage level VINT4 by a constant may be set as the offset voltage level VOFF.

In such an embodiment, the offset voltage level VOFF may be a voltage level based on a change of the initialization voltage VINT. The data voltage VDATA may have a voltage level based on the setting data voltage level SVDATA and the offset voltage level VOFF. Since the offset voltage level VOFF may be considered in the data voltage VDATA, a change of the voltage level of the initialization voltage VINT may be considered in the data voltage VDATA. Since a change of the voltage level of the initialization voltage VINT may be considered in the data voltage VDATA, the reliability of the driving current ID outputted by the driving transistor DT may be improved. Since the reliability of the driving current ID outputted by the driving transistor DT may be improved, the luminance uniformity of the display panel 100 may be improved. Accordingly, the display quality of the display panel 100 may be improved.

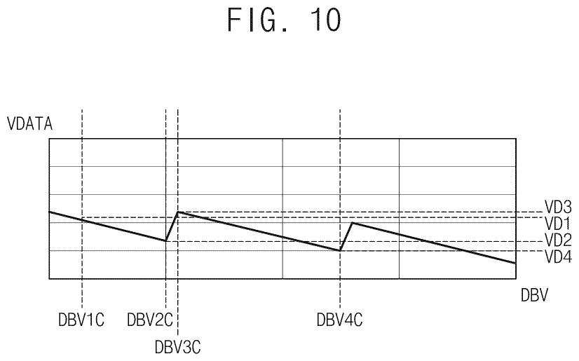

FIG. 9 is a graph illustrating an example of an offset voltage level VOFF considered for a data voltage VDATA of FIG. 6.

Referring to FIG. 1 to FIG. 9, in an embodiment, the offset voltage level VOFF may be changed based on the setting luminance DBV. The change rate of the offset voltage level VOFF may be changed based on the setting luminance DBV. In an embodiment, for example, an increase rate of the offset voltage level VOFF may be changed based on the setting luminance DBV. In an embodiment, for example, when the setting luminance DBV is increased, the offset voltage level VOFF may be increased. In an embodiment, for example, when the setting luminance DBV is increased, the increase rate of the offset voltage level VOFF may be increased. In an embodiment, for example, the offset voltage level VOFF may be determined using Equation 1.

VOFF=(DBV1B−DBV3B)/(DBV2B−DBV1B)×ASVDATA(A,B)×ΔVINT [Equation 1]

In Equation 1, VOFF denotes an offset voltage level VOFF, DBV1B denotes a first setting luminance DBV1B in which an initialization voltage VINT is changed, DBV3B denotes a second setting luminance DBV2B in which an initialization voltage VINT is changed, ΔSVDATA (A,B) denotes a voltage level difference between a setting data voltage level SVDATA corresponding to the first setting luminance DBV1B and a setting data voltage level SVDATA corresponding to the second setting luminance DBV2B, and ΔVINT denotes a voltage level difference between an initialization voltage level at the first setting luminance DBV1B and an initialization voltage level at the second setting luminance DBV2B.

In such an embodiment, the offset voltage level VOFF may be a voltage level based on a change of the initialization voltage VINT. The data voltage VDATA may have a voltage level based on the setting data voltage level SVDATA and the offset voltage level VOFF. Since the offset voltage level VOFF may be considered in the data voltage VDATA, a change of the voltage level of the initialization voltage VINT may be considered in the data voltage VDATA. Since a change of the voltage level of the initialization voltage VINT may be considered in the data voltage VDATA, the reliability of the driving current ID outputted by the driving transistor DT may be improved. Since the reliability of the driving current ID outputted by the driving transistor DT may be improved, the luminance uniformity of the display panel 100 may be improved. Accordingly, the display quality of the display panel 100 may be improved.

In such an embodiment, the offset voltage level VOFF may be changed based on the setting luminance DBV. In an embodiment, for example, the increase rate of the offset voltage level VOFF may be changed based on the setting luminance DBV. Accordingly, the luminance uniformity of the display panel 100 may be further improved. Accordingly, the display quality of the display panel 100 may be further improved.

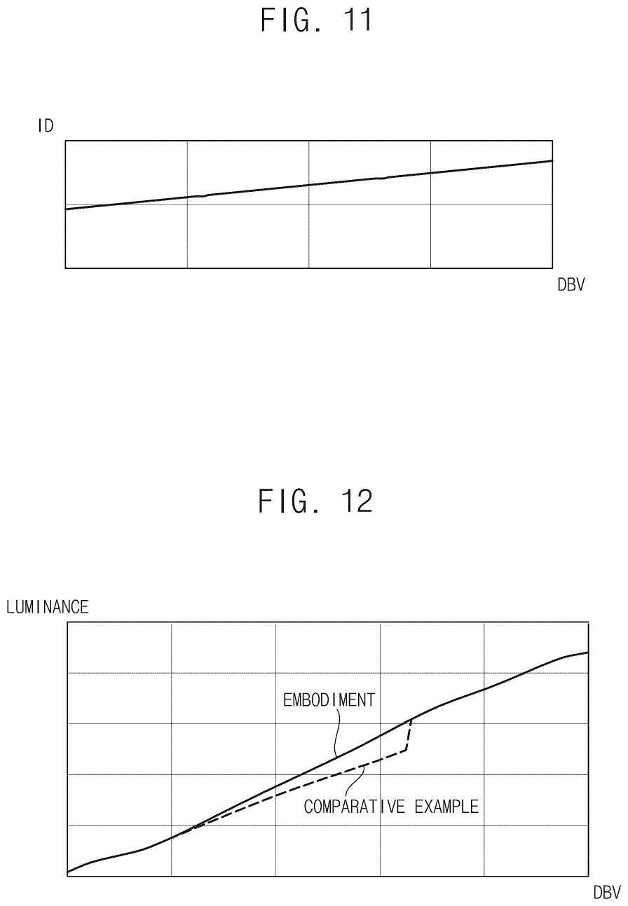

FIG. 10 is a graph illustrating an example of a data voltage VDATA in which a data driver 500 included in a display device 1 of FIG. 1 outputs. FIG. 11 is a graph illustrating an example of a driving current ID of a driving transistor DT included in a pixel circuit PX of FIG. 2.

Referring to FIG. 1 to FIG. 10, in an embodiment, the data driver 500 may apply the data voltage VDATA based on the setting data voltage level SVDATA and the offset voltage level VOFF to the pixel circuit PX.

When the setting luminance DBV is lower than the reference setting luminance RDBV, the data voltage VDATA may be lowered from the first data voltage level VD1 to the second data voltage level VD2 based on a change of the setting luminance DBV. In an embodiment, for example, when the setting luminance DBV is the first setting luminance DBV1C, the data voltage VDATA corresponding to the first grayscale may have the first data voltage level VD1. In an embodiment, for example, when the setting luminance DBV is the second setting luminance DBV2C, the data voltage VDATA corresponding to the first grayscale may have the second data voltage level VD2. The second data voltage level VD2 may be lower than the first data voltage level VD1.

When the setting luminance DBV is equal to or higher than the reference setting luminance RDBV, the data voltage VDATA may be lowered from a third data voltage level VD3 to a fourth data voltage level VD4 based on a change of the setting luminance DBV. In an embodiment, for example, when the setting luminance DBV is the third setting luminance DBV3C, the data voltage VDATA corresponding to the first grayscale may have the third data voltage level VD3. In an embodiment, for example, when the setting luminance DBV is the fourth setting luminance DBV4C, the data voltage VDATA corresponding to the first grayscale may have the fourth data voltage level VD4. The fourth data voltage level VD4 may be lower than the third data voltage level VD3.

In such an embodiment, the third data voltage level VD3 may be higher than the second data voltage level VD2. Accordingly, when the initialization voltage VINT is changed based on the setting luminance DBV, the offset voltage level VOFF may be considered in the data voltage VDATA. The offset voltage level VOFF may be a voltage level based on the change of the initialization voltage VINT. The data voltage VDATA may have a voltage level based on the setting data voltage level SVDATA and the offset voltage level VOFF. Since the offset voltage level VOFF may be considered in the data voltage VDATA, the voltage level change of the initialization voltage VINT may be considered in the data voltage VDATA. Since the voltage level change of the initialization voltage VINT may be considered in the data voltage VDATA, the reliability of the driving current ID outputted by the driving transistor DT may be improved as shown in FIG. 11. Since the reliability of the driving current ID outputted by the driving transistor DT may be improved, the luminance uniformity of the display panel 100 may be improved. Accordingly, the display quality of the display panel 100 may be improved.

FIG. 12 is a graph illustrating a luminance of a display panel 100 included in a display device 1 of FIG. 1 and a luminance of a comparative example.

Referring to FIG. 1 to FIG. 12, in a display device of a comparative example, when the initialization voltage VINT is changed, the offset voltage level VOFF may not be considered in the data voltage VDATA. Accordingly, the luminance uniformity may deteriorate after the initialization voltage VINT changed.

In an embodiment of the display device 1, as described above, when the initialization voltage VINT is changed based on the setting luminance DBV, the offset voltage level VOFF may be considered in the data voltage VDATA. The offset voltage level VOFF may be a voltage level based on the change of the initialization voltage VINT. The data voltage VDATA may have a voltage level based on the setting data voltage level SVDATA and the offset voltage level VOFF. Since the offset voltage level VOFF may be considered in the data voltage VDATA, the voltage level change of the initialization voltage VINT may be considered in the data voltage VDATA. Since the voltage level change of the initialization voltage VINT may be considered in the data voltage VDATA, the reliability of the driving current ID outputted by the driving transistor DT may be improved. Since the reliability of the driving current ID outputted by the driving transistor DT may be improved, the luminance uniformity of the display panel 100 may be improved as shown in FIG. 12. Accordingly, the display quality of the display panel 100 may be improved.

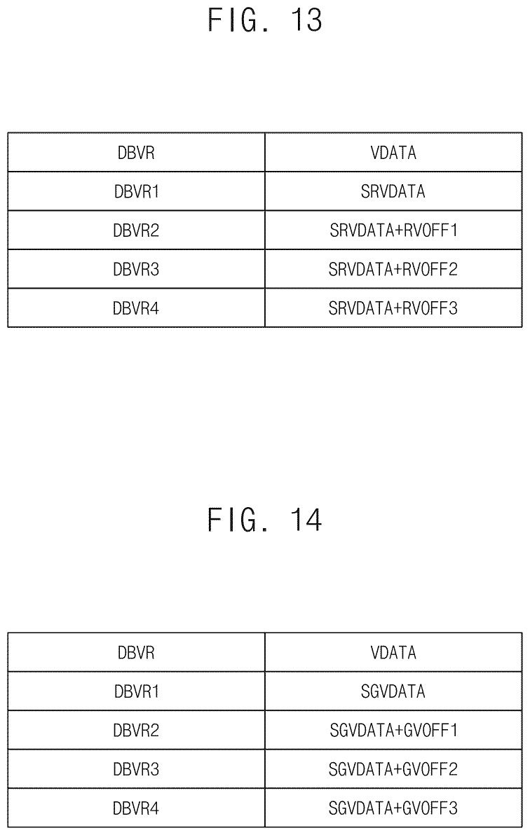

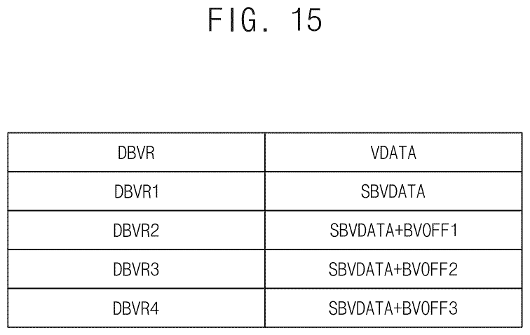

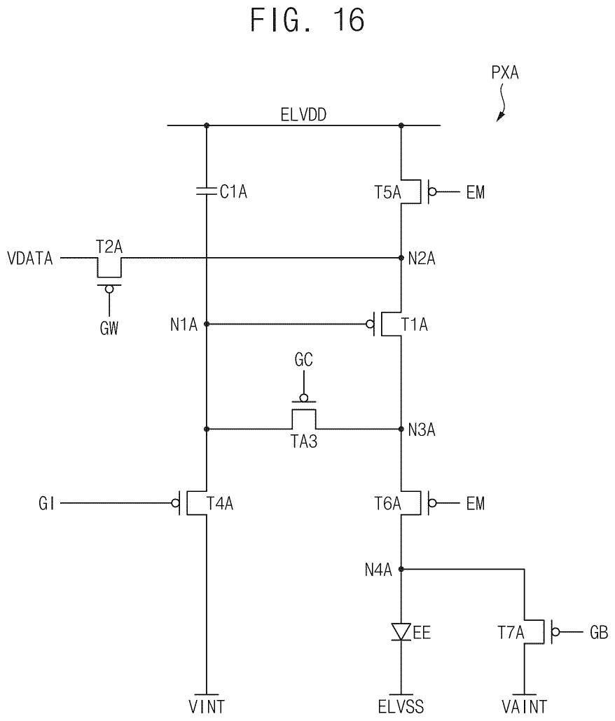

FIG. 13 is a table illustrating an example of a data voltage VDATA applied to a pixel circuit PX of FIG. 2. FIG. 14 is a table illustrating an example of a data voltage applied to a pixel circuit PX of FIG. 2. FIG. 15 is a table illustrating an example of a data voltage VDATA applied to a pixel circuit PX of FIG. 2.

Referring to FIG. 1 to FIG. 15, in an embodiment, different data voltages VDATA may be applied based on a color of the light emitting element EE included in the pixel circuit PX.

In the first setting luminance range DBVR1, the data driver 500 may apply a red setting data voltage level SRVDATA to the pixel circuit PX as shown in FIG. 13. In the second setting luminance range DBVR2, the data driver 500 may output a voltage level that is a sum of the red setting data voltage level SRVDATA and a first red offset voltage level RVOFF1 as the data voltage VDATA to the pixel circuit PX. In the third setting luminance range DBVR3, the data driver 500 may output a voltage level which is a sum of the red setting data voltage level SRVDATA and a second red offset voltage level RVOFF2 as the data voltage VDATA to the pixel circuit PX. In an embodiment, the second red offset voltage level RVOFF2 may be equal to the first red offset voltage level RVOFF1. In an embodiment, the second red offset voltage level RVOFF2 may be higher than the first red offset voltage level RVOFF1. In the fourth setting luminance range DBVR4, the data driver 500 may output a voltage level which is a sum of the red setting data voltage level SRVDATA and a third red offset voltage level RVOFF3 as the data voltage VDATA to the pixel circuit PX. In an embodiment, the third red offset voltage level RVOFF3 may be equal to the second red offset voltage level RVOFF2. In an embodiment, the third red offset voltage level RVOFF3 may be higher than the second red offset voltage level RVOFF2.

In the first setting luminance range DBVR1, the data driver 500 may apply a green setting data voltage level SGVDATA to the pixel circuit PX as shown in FIG. 14. In the second setting luminance range DBVR2, the data driver 500 may output a voltage level which is a sum of the green setting data voltage level SGVDATA and a first green offset voltage level GVOFF1 as the data voltage VDATA to the pixel circuit PX. In the third setting luminance range DBVR3, the data driver 500 may output a voltage level which is a sum of the green setting data voltage level SGVDATA and a second green offset voltage level GVOFF2 as the data voltage VDATA to the pixel circuit PX. In an embodiment, the second green offset voltage level GVOFF2 may be equal to the first green offset voltage level GVOFF1. In an embodiment, the second green offset voltage level GVOFF2 may be higher than the first green offset voltage level GVOFF1. In the fourth setting luminance range DBVR4, the data driver 500 may output a voltage level which is a sum of the green setting data voltage level SGVDATA and a third green offset voltage level GVOFF3 as the data voltage VDATA to the pixel circuit PX. In an embodiment, the third green offset voltage level GVOFF3 may be equal to the second green offset voltage level GVOFF2. In an embodiment, the third green offset voltage level GVOFF3 may be higher than the second green offset voltage level GVOFF2.

In the first setting luminance range DBVR1, the data driver 500 may apply a blue setting data voltage level SBVDATA to the pixel circuit PX as shown in FIG. 15. In the second setting luminance range DBVR2, the data driver 500 may output a voltage level which is a sum of the blue setting data voltage level SBVDATA and the first blue offset voltage level BVOFF1 as the data voltage VDATA to the pixel circuit PX. In the third setting luminance range DBVR3, the data driver 500 may output a voltage level which is a sum of the blue setting data voltage level SBVDATA and a second blue offset voltage level BVOFF2 as the data voltage VDATA to the pixel circuit PX. In an embodiment, the second blue offset voltage level BVOFF2 may be equal to the first blue offset voltage level BVOFF1. In an embodiment, the second blue offset voltage level BVOFF2 may be higher than the first blue offset voltage level BVOFF1. In the fourth setting luminance range DBVR4, the data driver 500 may output a voltage level which is a sum of the blue setting data voltage level SBVDATA and the third blue offset voltage level BVOFF3 as the data voltage VDATA to the pixel circuit PX. In an embodiment, the third blue offset voltage level BVOFF3 may be equal to the second blue offset voltage level BVOFF2. In an embodiment, the third blue offset voltage level BVOFF3 may be higher than the second blue offset voltage level BVOFF2.

In such an embodiment, the red offset voltage levels RVOFF1, RVOFF2 and RVOFF3, the green offset voltage levels GVOFF1, GVOFF2 and GVOFF3 and the blue offset voltage levels BVOFF1, BVOFF2 and BVOFF3 may be different from each other.

In an embodiment, the first green offset voltage level GVOFF1 may be higher than the first red offset voltage level RVOFF1. The first red offset voltage level RVOFF1 may be higher than the first blue offset voltage level BVOFF1. The second green offset voltage level GVOFF2 may be higher than the second red offset voltage level RVOFF2. The second red offset voltage level RVOFF2 may be higher than the second blue offset voltage level BVOFF2. The third green offset voltage level GVOFF3 may be higher than the third red offset voltage level RVOFF3. The third red offset voltage level RVOFF3 may be higher than the third blue offset voltage level BVOFF3. Accordingly, the offset voltage level VOFF may be considered differently based on a color having a substantial effect on luminance. Accordingly, the luminance uniformity of the display panel 100 may be further improved.

In such an embodiment, when the initialization voltage VINT is changed based on the setting luminance DBV, the offset voltage level VOFF may be considered in the data voltage VDATA. The offset voltage level VOFF may be a voltage level based on the change of the initialization voltage VINT. The data voltage VDATA may have a voltage level based on the setting data voltage level SVDATA and the offset voltage level VOFF. Since the offset voltage level VOFF may be considered in the data voltage VDATA, the voltage level change of the initialization voltage VINT may be considered in the data voltage VDATA. Since the voltage level change of the initialization voltage VINT may be considered in the data voltage VDATA, the reliability of the driving current ID outputted by the driving transistor DT may be improved. Since the reliability of the driving current ID outputted by the driving transistor DT may be improved, the luminance uniformity of the display panel 100 may be improved. Accordingly, the display quality of the display panel 100 may be improved.

In an embodiment, the red offset voltage levels RVOFF1, RVOFF2 and RVOFF3, the green offset voltage levels GVOFF1, GVOFF2 and GVOFF3, and the blue offset voltage levels BVOFF1, BVOFF2 and BVOFF3 may be different from each other. Since the red offset voltage levels RVOFF1, RVOFF2 and RVOFF3, the green offset voltage levels GVOFF1, GVOFF2 and GVOFF3, and the blue offset voltage levels BVOFF1, BVOFF2 and BVOFF3 may be different, a color uniformity of the display panel 100 may be improved.

FIG. 16 is a circuit diagram illustrating an example of a pixel circuit PX included in the display device 1 of FIG. 1.

Referring to FIG. 1 to FIG. 16, an embodiment of a pixel circuit PXA may include a first transistor T1A, a second transistor T2A, a third transistor T3A, a fourth transistor T4A, a fifth transistor T5A, a sixth transistor T6A, a seventh transistor T7A, a first capacitor C1A and a light emitting element EE.

The first transistor TIA may include a control electrode connected to a first node N1A, a first electrode connected to a second node N2A and a second electrode connected to a third node N3A. The first transistor TIA may generate a driving current based on a voltage of the first node NIA. In an embodiment, for example, the first transistor TIA may be called as the driving transistor. In an embodiment, as shown in FIG. 16, the first transistor TIA may be a P-type transistor.

The second transistor T2A may include a control electrode that receives the write gate signal GW[n], a first electrode that receives the data voltage VDATA and a second electrode connected to the second node N2A. The second transistor T2A may apply the data voltage VDATA to the second node N2A in response to the write gate signal GW[n]. In an embodiment, for example, the second transistor T2A may be called as a writing transistor.

The third transistor T3A may include a control electrode that receives the compensation gate signal GC[n], a first electrode connected to the third node N3 A and a second electrode connected to the first node NIA. The third transistor T3A may connect the first node N1A and the third node N3A in response to the compensation gate signal GC[n]. In an embodiment, for example, the third transistor T3A may diode-connect the first transistor TIA (i.e., connect the first transistor T1A in a diode form) in response to the compensation gate signal GC[n]. In an embodiment, for example, the third transistor T3A may be called as a compensation transistor.

The fourth transistor T4A may include a control electrode that receives the initialization gate signal GI[n], a first electrode that receives the initialization voltage VINT and a second electrode connected to the first node NIA. The fourth transistor T4A may apply the initialization voltage VINT to the first node NIA in response to the initialization gate signal GI[n]. In an embodiment, for example, the fourth transistor T4A may be called as an initialization transistor.

The fifth transistor T5A may include a control electrode that receives the emission signal EM[n], a first electrode that receives the high power voltage ELVDD and a second electrode connected to the second node N2A. The fifth transistor T5A may apply the first power voltage ELVDD to the second node N2A in response to the emission signal EM[n]. In an embodiment, for example, the fifth transistor T5A may be called as a first emission transistor.

The sixth transistor T6A may include a control electrode that receives the emission signal EM[n], a first electrode connected to the third node N3A and a second electrode connected to the fourth node N4A. The sixth transistor T6A may connect the third node N3A and the fourth node N4A in response to the emission signal EM[n]. In an embodiment, for example, the sixth transistor T6A may be called as a second emission transistor.

The seventh transistor T7A may include a control electrode that receives a light emitting element initialization gate signal GB[n], a first electrode that receives a light emitting element initialization voltage VAINT and a second electrode connected to a fourth node N4A. The seventh transistor T7A may apply the light emitting element initialization voltage VAINT to the fourth node N4A in response to the light emitting element initialization gate signal GB[n].

The first capacitor C1A may include a first electrode that receives the first power voltage ELVDD and a second electrode connected to the first node NIA. The first capacitor CIA may store a voltage of the first node NIA. In an embodiment, for example, the first capacitor C1A may be called as a storage capacitor.

The light emitting element EE may include a first electrode connected to the fourth node N4A and a second electrode that receives the low power voltage ELVSS. The light emitting element EE may emit light based on the driving current.

In an embodiment, as illustrated in FIG. 16, the pixel circuit PX may have a seven transistor and one capacitor (7T1C) structure. However, the invention is not limited to the structure of the pixel circuit PX. For example, embodiments of the invention may be applied to the pixel circuit PX in which a driving transistor is diode-connected and internally compensated. For example, embodiments of the invention may be applied to the pixel circuit PX to which the data voltage VDATA is applied through a first electrode of a driving transistor.

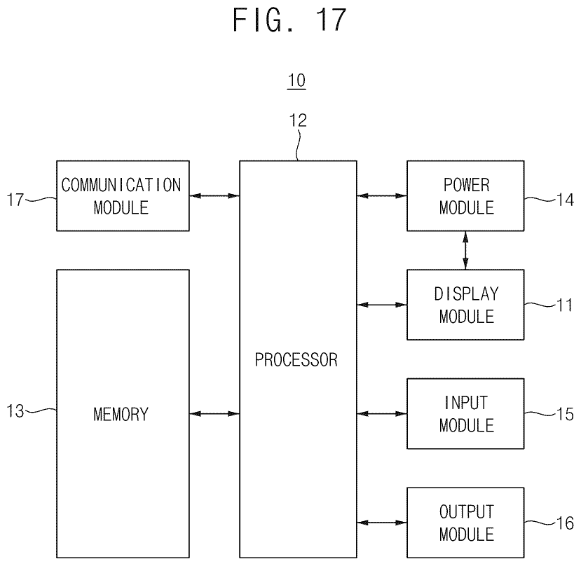

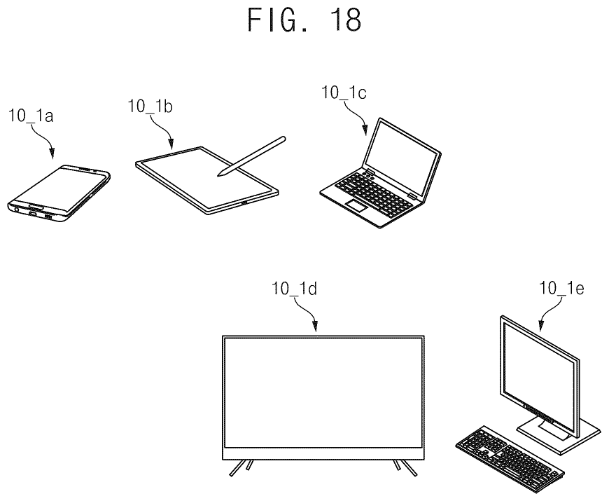

FIG. 17 is a block diagram illustrating an electronic device 10 according to embodiments of the invention.

Referring to FIG. 17, an electronic device 10 according to an embodiment may include a display module 11, a processor 12, a memory 13 and a power module 14.

The processor 12 may include at least one selected from a central processing unit (CPU), an application processor (AP), a graphic processing unit (GPU), a communication processor (CP), an image signal processor (ISP), and a controller.

The memory 13 may store data information used for the operation of the processor 12 or the display module 11. When the processor 12 executes an application stored in the memory 13, an image data signal and/or an input control signal is transmitted to the display module 11, and the display module 11 may process the received signal and output image information through a display screen.

The power module 14 may include a power supply module, such as a power adapter or a battery device, and a power conversion module which converts power supplied by the power supply module to generate power used for the operation of the electronic device 10.

The electronic device 10 may further include an input module 15, a non-image output module 16 and/or a communication module 17.

The input module 15 may provide input information to the processor 12 and/or the display module 11. The input module 15 may include various sensor modules as well as physical buttons, a keyboard, and a microphone. Examples of the sensor modules may include a touch sensor, a pressure sensor, a distance sensor, a position sensor, a digitizer, a motion recognition sensor, a camera sensor, a light receiving sensor, a photoelectric conversion sensor, a temperature sensor, and a biosensor such as a blood pressure sensor, a blood sugar sensor, an electrocardiogram sensor, and a heart rate sensor.

The non-image output module 16 may receive information other than images from the processor 12 and provide the information to the user. Examples of the non-image output module 16 may include an audio module, a haptic module, a light-emitting module, etc., and may include other functional modules unique to electronic devices (e.g., a cooling module of a refrigerator, etc.).

The communication module 17 may be a module that is responsible for transmitting and receiving information between the electronic device 10 and an external device, and may include a receiving unit and a transmitting unit. The communication module 17 may include various wireless communication modules such as a mobile communication module, a Wi-Fi module, a Bluetooth module, or various wired communication modules.

At least one of the components of the electronic device 10 described above may be included in the display device according to the embodiments described above. Additionally, some of the individual modules functionally included in one module may be included in the display device, and other may be provided separately from the display device. In an embodiment, for example, the display device may include the display module 11, and the processor 12, the memory 13, and the power module 14 may be provided in the form of other devices within the electronic device 10 other than the display device.

FIG. 18 to FIG. 20 are schematic diagrams illustrating an electronic device according to embodiments.

Referring to FIG. 18, examples of electronic devices may include a smartphone 10_1a, a tablet personal computer (PC) 10_1b, a laptop 10_1c, a television (TV) 10_1d, and a desk monitor 10_1e.

The smartphone 10_1a may include an input module such as a touch sensor and a communication module in addition to the display module 11. The smartphone 10_1a may process information received through the communication module or other input modules and display the information through the display module of the display device.

In an embodiment where the electronic device is tablet PC 10_1b, laptop 10_1c, TV 10_1d, or desk monitor 10_1e, the electronic device may include a display module and an input module similar to the smartphone 10_1a, and in some cases, may further include a communication module.

Referring to FIG. 19, an electronic device including a display module may be applied to a wearable electronic device. The wearable electronic device may be a smart glasses 10_2a, a head mounted display 10_2b, a smart watch 10_2c, etc.

The smart glasses 10_2a and head mounted displays 10_2b may include a display module which outputs a display image and a reflector which reflects the emitted display image and provides the reflected display image to the user's eyes, thereby providing a virtual reality or augmented reality screen to the user.

The smartwatch 10_2c may include a biometric sensor as an input device and may provide biometric information recognized by the biometric sensor to the user through a display module.

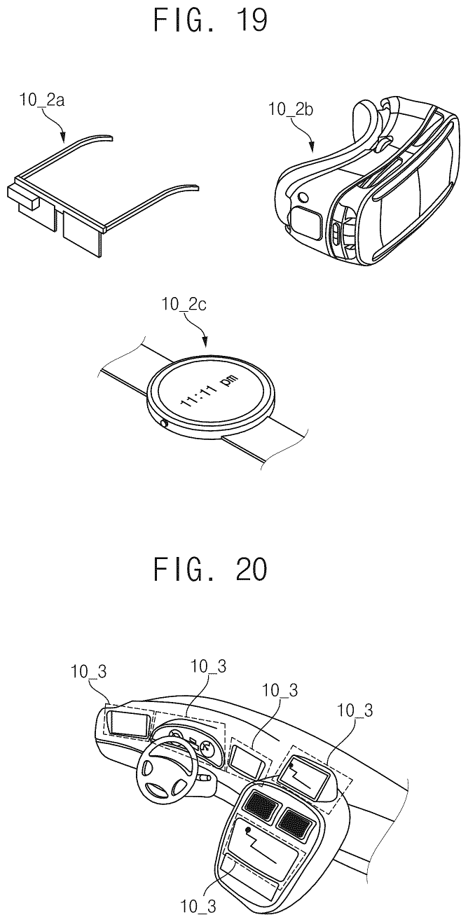

Referring to FIG. 20, an electronic device including a display module may be applied to a vehicle. For example, the electronic device 10_3 may be applied to a dashboard, center fascia, etc. of a vehicle, or may be applied to a center information display (CID) placed on a dashboard of a vehicle or a room mirror display replacing a side mirror.

Although not illustrated, electronic devices to which the display device according to the embodiments is applied may include not only devices that mainly display screens, such as billboards, electronic boards, and game consoles, but also various home appliances that display information through display modules, such as refrigerators, washing machines, dryers, air conditioners, and robot vacuum cleaners. Additionally, when the display module has a function of transmitting light, it may be applied to electronic devices, such as smart windows or transparent display devices that display a background and a display image together. The type of electronic device according to the embodiment is not limited by the examples, and application to other various electronic devices that are not illustrated may also be possible.

The display device according to the embodiments may be applied to a display device included in a computer, a notebook, a mobile phone, a smart phone, a smart pad, a portable media player (PMP), a personal digital assistant (PDA), an MP3 player, or the like.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display device comprising:
a display panel including a pixel circuit;
a gate driver which outputs a gate signal to the pixel circuit;
a data driver which applies a data voltage to the display panel;
a voltage generator which applies a driving voltage to the display panel; and
a driving controller which controls the gate driver, the data driver and the voltage generator,
wherein the pixel circuit includes:
a driving transistor which generates a driving current based on the data voltage; and
a light emitting element which emits light based on the driving current,
wherein the driving voltage includes an initialization voltage applied to a control electrode of the driving transistor,
wherein the initialization voltage is changed based on a setting luminance of the display panel, and
wherein when the initialization voltage is changed, the data voltage has a voltage level which is a sum of a setting data voltage level and an offset voltage level.

2. The display device of claim 1, wherein when the setting luminance is a first setting luminance, the initialization voltage has a first initialization voltage level, and the data voltage has the setting data voltage level corresponding to the first setting luminance, and
wherein the setting luminance is a second setting luminance higher than the first setting luminance, the initialization voltage has a second initialization voltage level different from the first initialization voltage level, and the data voltage has a voltage which is a sum of the setting data voltage level corresponding to the second setting luminance and a first offset voltage level.

3. The display device of claim 2, wherein the second initialization voltage level is lower than the first initialization voltage level.

4. The display device of claim 2, wherein the setting luminance is a third setting luminance higher than the second setting luminance, the initialization voltage has a third initialization voltage level different from the first initialization voltage level and the second initialization voltage level, and the data voltage has a voltage which is a sum of the setting data voltage level corresponding to the third setting luminance and a second offset voltage level, and
wherein the second offset voltage level is different from the first offset voltage level.

5. The display device of claim 4, wherein a voltage level difference between the second offset voltage level and the first offset voltage level is different from the first offset voltage level.

6. The display device of claim 5, wherein a change rate of the offset voltage level is changed based on the setting luminance.

7. The display device of claim 1, wherein the setting data voltage level is determined based on a grayscale voltage lookup table corresponding to the setting luminance.

8. The display device of claim 7, wherein when the setting luminance is equal to or higher than a reference setting luminance, the setting data voltage level is determined based on one grayscale voltage lookup table of a plurality of grayscale voltage lookup tables, and
wherein the one grayscale voltage lookup table is generated through a linear interpolation to a reference grayscale voltage lookup table stored at the reference setting luminance and a maximum grayscale voltage lookup table stored at a luminance setting luminance.

9. The display device of claim 1, wherein the offset voltage level is determined based on a change of the initialization voltage.

10. The display device of claim 1, wherein the light emitting element includes a first electrode which receives the driving current and a second electrode which receives a low power voltage, and
wherein when the low power voltage is changed, the initialization voltage is changed.

11. The display device of claim 1, wherein the data voltage includes a red data voltage, a green data voltage and a blue data voltage,
wherein when the initialization voltage is changed, the red data voltage has a voltage level which is a sum of a red setting data voltage level and a red offset voltage level,
wherein when the initialization voltage is changed, the green data voltage has a voltage level which is a sum of a green setting data voltage level and a green offset voltage level,
wherein when the initialization voltage is changed, the blue data voltage has a voltage level which is a sum of a blue setting data voltage level and a blue offset voltage level, and
wherein the red offset voltage level, the green offset voltage level and the blue offset voltage level are different from each other.

12. The display device of claim 11, wherein the green offset voltage level is higher than the red offset voltage level, and
wherein the red offset voltage level is higher than the blue offset voltage level.

13. A display device comprising:
a display panel including a pixel circuit; and
a display panel driver which drives the display panel,
wherein the display panel driver applies a data voltage and an initialization voltage to the display panel,
wherein the initialization voltage is changed based on a setting luminance of the display panel,
wherein when the setting luminance is lower than a reference setting luminance, the data voltage is decreased from a first data voltage level to a second data voltage level based on a change of the setting luminance,
wherein when the setting luminance is equal to or higher than the reference setting luminance, the data voltage is decreased from a third data voltage level to a fourth data voltage level based on the change of the setting luminance, and
wherein the third data voltage level is higher than the second data voltage level.

14. The display device of claim 13, wherein when the setting luminance is lower than the reference setting luminance, the initialization voltage has a first initialization voltage level, and
wherein when the setting luminance is equal to or higher than the reference setting luminance, the initialization voltage is decreased from the first initialization voltage.

15. The display device of claim 14, wherein when the setting luminance is lower than the reference setting luminance, the data voltage has a setting data voltage level corresponding to the setting luminance, and
wherein when the setting luminance is equal to or higher than the reference setting luminance, the data voltage has a voltage level which is a sum of the setting data voltage level corresponding to the setting luminance and an offset voltage level.

16. The display device of claim 15, wherein the setting data voltage level is determined based on a grayscale voltage lookup table corresponding to the setting luminance,
wherein when the setting luminance is equal to or higher than a reference setting luminance, the setting data voltage level is determined based on one grayscale voltage lookup table of a plurality of grayscale voltage lookup tables, and
wherein the one grayscale voltage lookup table is generated through a linear interpolation to a reference grayscale voltage lookup table stored at the reference setting luminance and a maximum grayscale voltage lookup table stored at a luminance setting luminance.

17. An electronic device comprising:
a display panel including a pixel circuit;
a gate driver which outputs a gate signal to the pixel circuit;
a data driver which applies a data voltage to the display panel;
a voltage generator which applies a driving voltage to the display panel;
a driving controller which controls the gate driver, the data driver and the voltage generator based on an input control signal; and
a processor which outputs the input control signal,
wherein the pixel circuit includes:
a driving transistor which generates a driving current based on the data voltage; and
a light emitting element which emits light based on the driving current,
wherein the driving voltage includes an initialization voltage applied to a control electrode of the driving transistor,
wherein the initialization voltage is changed based on a setting luminance of the display panel, and
wherein when the initialization voltage is changed, the data voltage has a voltage level which is a sum of a setting data voltage level and an offset voltage level.

18. The electronic device of claim 17, wherein when the setting luminance is a first setting luminance, the initialization voltage has a first initialization voltage level, and the data voltage has the setting data voltage level corresponding to the first setting luminance, and
wherein the setting luminance is a second setting luminance higher than the first setting luminance, the initialization voltage has a second initialization voltage level different from the first initialization voltage level, and the data voltage has a voltage which is a sum of the setting data voltage level corresponding to the second setting luminance and a first offset voltage level.

19. The electronic device of claim 18, wherein the setting luminance is a third setting luminance higher than the second setting luminance, the initialization voltage has a third initialization voltage level different from the first initialization voltage level and the second initialization voltage level, and the data voltage has a voltage which is a sum of the setting data voltage level corresponding to the third setting luminance and a second offset voltage level, and
wherein the second offset voltage level is different from the first offset voltage level.

20. The electronic device of claim 17, wherein the offset voltage level is determined based on a change of the initialization voltage.
